(19) United States
(12) Patent Application Publication
(10) Pub. No.: US 2009/0109369 A1
(43) Pub. Date: Apr. 30, 2009

(54) LIQUID CRYSTAL DISPLAY DEVICE

(75) Inventor: Hitoshi MORISHITA, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 12/255,845

(22) Filed: Oct. 22, 2008

(30) Foreign Application Priority Data
Oct. 26, 2007 (JP) 2007-279011

(51) Int. Cl. G02F 1/1333; G02F 1/1343

(52) U.S. Cl. 349/58; 349/139

(57) ABSTRACT

In accordance with one aspect of the present invention, a liquid crystal display device having a liquid crystal display panel including a array substrate 10 and an opposed substrate 20 arranged in opposed positions, includes a display area 42, a projection area 40 formed by projecting one edge of the array substrate 10 beyond the opposed substrate on the outside of the display area 42, an electrode terminal 60 formed in the projection area 40, an overhang area 41 formed by overhanging a part of the side edge on the projection area 40 side of the opposed substrate 20, when viewed from the top, toward the side edge of the array substrate located on the projection area 40 side, a conductive film 21 formed on the opposed substrate, and Ag paste 34 formed in the overhang area 41 and electrically connected to the conductive film 21.

### BACKGROUND OF THE INVENTION

1. Field of the Invention

The present invention relates to a liquid crystal display device, in particular a liquid crystal display device having an overhang area in a part of the substrate.

2. Description of Related Art

Improvements in the performance of liquid crystal display devises have been remarkably in recent years. In particular, requirements for a wider viewing angle have become higher, and various techniques such as the IPS mode and the VA mode have been proposed and adopted. Especially, the IPS mode excels other techniques in its wider viewing angle. However, the IPS mode also has a disadvantage that the alignment state of the liquid crystal and thereby the display state tend to be easily disturbed by external electrical fields. To solve problem like this, Japanese Unexamined Patent Application Publication No. 10-268783 discloses a technique in which a conductive layer is stuck over the polarizing plate that is in turn stuck on the color filter substrate. Then, the polarizing plate is connected to the housing frame by conductive material in order to eliminate the influence of external electrical fields.

However, there has been a concern that the infiltration of foreign substances and the difference in expansion rates may cause wrinkles and warping in such a structure in which a conductive film is stuck over the polarizing plate, and thereby decreasing the yield rate. Furthermore, the conductive material used to connect the housing frame to the polarizing plate occupies some extent of area. There is a disadvantage that since the conductive material is formed outside of the display area of a liquid crystal display devise, the frame area needs to be increased.

Furthermore, Japanese Unexamined Patent Application Publication No. 2005-77590 discloses a structure using conductive rubber. Specifically, a transparent conductive film is formed on the underside of the color filter substrate, and the conductive film is electrically connected with the frame through the conductive rubber. However, similarly to the previous structure, the area outside of the display area needs to be also increased to secure the area used for the electrical connection in this structure. Therefore, there is a disadvantage that the fame area needs to be increased.

The present invention is to solve such problems, and one of the objects of the present invention is to provide a liquid crystal display devise that is less susceptible to external electrical fields and capable of reducing the frame area.

### SUMMARY OF THE INVENTION

In accordance with one aspect of the present invention, a liquid crystal display device having a liquid crystal display panel including a first substrate and a second substrate arranged in opposed positions, includes: a display area; a projection area where one edge of the first substrate projects beyond the second substrate on the outside of the display area; an electrode terminal formed in the projection area; an overhang area where a part of the side edge on the projection area side of the second substrate overhangs, when viewed from the top, toward the side edge on the projection area side of the first substrate; a conductive film formed on the second substrate; and a conductive material formed in the overhang area, the conductive material being electrically connected to the conductive film.

The present invention can provide a liquid crystal display devise that is less susceptible to external electrical fields and capable of reducing the frame area.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIGS. 1A and 1B show a liquid crystal display panel in accordance with a first embodiment of the present invention;

FIG. 2 is a top view showing the structure of large cell in accordance with the first embodiment of the present invention;

FIG. 3 is a top view showing the structure of a stick in accordance with the first embodiment of the present invention;

FIG. 4 is a top view showing an application place of insulating resin in accordance with a second embodiment of the present invention;

FIG. 5 is a top view showing the structure of a projection area in accordance with a third embodiment of the present invention before a driver LSI and a FPC are connected;

FIG. 6 is a top view showing the structure of a liquid crystal display panel in accordance with a fourth embodiment of the present invention;

FIG. 7 is a cross-section showing the structure of a liquid crystal display devise in accordance with the fourth embodiment of the present invention; and

FIG. 8 is a cross-section showing the structure of a liquid crystal display devise in accordance with a fifth embodiment of the present invention.

### DETAILED DESCRIPTION OF THE PREFERRED EMBODIMENTS

Embodiments for the structures and the manufacturing methods of liquid crystal display devices in accordance with the present invention are explained hereinafter. Note that the same signs are used for substantially the same components throughout the drawings.

### First Embodiment

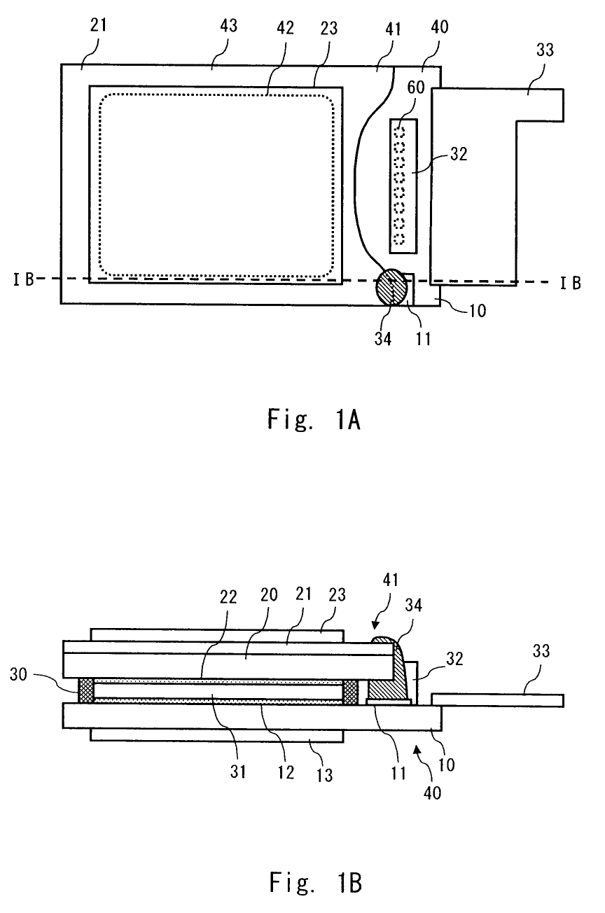

Firstly, a liquid crystal display devise in accordance with a first embodiment of the present invention is explained hereinafter with reference to FIGS. 1A and 1B. FIG. 1A is a top view showing the structure of a liquid crystal display panel. FIG. 1B is a cross-section taken along the line IB-IB in FIG. 1A. In this example, a liquid crystal display devise of the IPS mode is explained as one example of a liquid crystal display device.

The liquid crystal display devise includes a liquid crystal display panel, a backlight unit, a driving circuit, and the like. The liquid crystal display panel has such a structure that an array substrate 10 and an opposed substrate 20 are arranged opposite to each other, and a liquid crystal layer 31 is formed in the space enclosed by both substrates and sealing material 30 adhering these substrates. Both of the substrates are maintained so as to have a specific gap between the substrates by spacers.

Furthermore, among the array substrate 10 and the opposed substrate 20, the array substrate 10 is formed so as to have larger planar size than that of the opposed substrate 20. The array substrate 10 and the opposed substrate 20 are arranged such that the one edge of the array substrate 10 projects beyond the opposed substrate 20. Output lines or the likes for transferring scanning signals, display signals and the likes to electrodes formed on the array substrate 10 are formed on a projection area 40 where the one edge of the array substrate 10 projects beyond the opposed substrate 20. Furthermore, electrode terminals 60 are formed at the edges of the output lines in the projection area 40. A driver LSI 32 is connected to the electrode terminals 60 through an anisotropic conductive film of a type such as an ultraviolet curing type or a thermosetting type. The driver LSI 32 is provided directly on the array substrate 10 by using a COG (Chip On Glass) method. Furthermore, a flexible printed circuit (FPC) 33 is connected in the edge portion of the projection area 40.

Furthermore, parts of the edge portion on the projection area 40 side of the opposed substrate 20 overhang toward the edge portion on the projection area 40 side of the array substrate 10. That is, when views from the top, parts of the side edge on the projection area 40 side of the opposed substrate 20 overhang toward the side edge on the projection area 40 side of the array substrate 10. In FIG. 1A, parts of the right edge portion of the opposed substrate 20 overhang toward the right side. The areas of the opposed substrate 20 overhanging toward the projection area 40 side is referred to as “overhang areas 41” hereinafter. The distance from the side edge on the projection area 40 side of the opposed substrate 20 to the side edge on the projection area 40 side of the array substrate 10 is shorter in the overhang areas 41 than the distances in the other areas. Furthermore, the overhang areas 41, when viewed from the top, are preferably provided at the end portions of the side edge on the projection area 40 side of the opposed substrate 20, and formed in curved lines. Note that the overhang area 41 may be provided at both end portions of the side edge, or may be at either one of the end portions. In this embodiment, the overhang areas 41 are provided on both end portions of the side edge. In other words, the overhang areas 41 are provided at the two corner portions on the projection area 40 side of the opposed substrate 20, and formed in curved lines. Furthermore, the overhanging length of the overhang area 41 becomes gradually smaller in the direction toward the center portion.

As for the array substrate 10 that is used as a first substrate, a plurality of gate signal lines (scanning signal lines) and a plurality of source signal lines (display signal lines) are formed on an insulating substrate. The plurality of gate signal lines is arranged in parallel. Similarly, the plurality of source signal lines is also arranged in parallel. The gate signal lines and the source signal lines are formed so as to cross each other. The gate lines and source lines cross each other at right angles. Furthermore, the area defined by neighboring gate signal lines and neighboring source signal lines becomes a pixel. Therefore, the pixels are arranged in a matrix pattern on the array substrate 10. The area where pixels are formed in the matrix pattern is a display area 42. Furthermore, the area located outside of the display area 42 is a frame area 43. The frame area 43 has a projection area 40 in a part of it.

At least one switching element is formed with in each pixel. A thin-film transistor (TFT), for example, may be used as the switching element. The switching element is disposed in the vicinity of the intersection of the source signal line and the gate signal line. Pixel electrodes and a common electrode are formed in the array substrate 10. Each electrode is formed in a shape like the teeth of a comb. For example, the switching element supplies display voltage to the pixel electrode. That is, the switching element is turned on by a scanning signal from the gate signal line. In this way, the display voltage is applied from the source signal line to the pixel electrode connected to the drain electrode of the switching element. Then, an electrical field is generated between the pixel electrode and the common electrode in accordance with the display voltage. Furthermore, in the case of the IPS mode in which the pixel electrodes and the common electrode are formed on the array substrate 10 as explained above, the electrical field is generated in a direction along the surface of the substrate (in a transverse direction). Furthermore, the liquid crystal molecules rotate in the plane parallel to the substrate.

Furthermore, a ground electrode 11 is also formed in an area of the array substrate 10 that is opposed to the vicinity of the overhang area 41. In this embodiment, the overhang area 41 is provided on both end portions of the side edge on the projection area 40 side of the opposed substrate 20. Therefore, the ground electrode 11 is formed in either one of the portions of the array substrate 10 that are opposed to the vicinity of the overhang area 41, i.e., in an end portion of the array substrate 10. The ground electrode 11 is connected to a reference potential point. Furthermore, the ground electrode 11 is also connected to a conductive film 21 (which is explained later), and used to connect the conductive film 21 to ground.

The opposed substrate 20 that is used as a second substrate is, for example, a color filter substrate (CF substrate), and is disposed on the viewer side. The opposed substrate 20 has such a structure that a color filter, a black matrix (BM), and the like are formed on an insulating substrate. The color filter has colored layers of Red (R), Green (G), and Blue (B). Then, sets of the RGB are formed at such positions that one of colored layers is opposed to corresponding one of the pixels in the array substrate 10. That is, the colored layers of the RGB are formed in matrix patterns. Furthermore, column spacers that are formed from resin are formed above the colored layers of the RGB. That is, the column spacers are arranged in a speckled manner so as to be arranged between the patterns of the RGB, i.e., so as to be superposed on the BM pattern. The column spacers are used to maintain the fixed distance between the array substrate 10 and the opposed substrate 20 when they are superposed with each other. Then, a conductive film 21 is formed on the surface of the opposed substrate 20 that faces away from the array substrate 10, i.e., the opposite surface of the opposed substrate 20 to the surface on which the color filters and the likes are formed. The conductive film 21 is formed roughly throughout the entire surface of the opposed substrate 20. That is, the conductive film 21 is also formed over the overhang area 41. The conductive film 21 can be formed, for example, from a transparent conductive film such as ITO (Indium Tin Oxide) composed mainly of iridium. The conductive film 21 is connected to the ground electrode 11 through Ag paste 34, which is used as conductive material, so that the conductive film 21 is maintained at the reference potential. Incidentally, although the Ag paste 34 is used in the above explanation, other conductive material such as conductive resin may be used as a substitute. The Ag paste 34 is formed in the overhang area 41, and contacts with the ground electrode 11 and the conductive film 21. Since conductive film 21 is maintained at the reference potential in this manner, it can suppress the influence of external electrical fields.

Furthermore, alignment layers 12 and 22 are formed on the inner surfaces of the above-described array substrate 10 and opposed substrate 20 respectively. Furthermore, polarizing plates 13 and 23 are formed on the outer surfaces of the array substrate 10 and opposed substrate 20 respectively. That is, the conductive film 21 is formed between the opposed substrate 20 and the polarizing plate 23. Incidentally, a retardation film may be also provided in addition to these components.

The driver LSI 32 is, as described above, directly provided in the projection area 40 over the array substrate 10 by using the COG method. Furthermore, the driver LSI 32 is, when viewed from the top, provided between the two overhang areas 41. The liquid crystal display panel is driven by the driver LSI 32, which outputs various control signals, scanning voltage, display voltage, and the like necessary to display desired images based on an externally-input scanning signal, a display signal, and the like. Alternatively, a FPC on which a driver LSI 32 is mounted may be connected to the liquid crystal display panel.

Furthermore, a FPC 33 is adhered to the array substrate 10 at the outside of the driver LSI 32, in particular in the vicinity of the side edge on the projection area 40 side of the array substrate 10. The FPC 33 has a control circuit (not shown) and the like mounted thereon. The control circuit is provided therein with a controller for supplying a scanning signal, a display signal, various control signals, and the like to the driver LSI 32, a power supply circuit for supplying power supply voltage, reference voltage, and the like, and similar circuits. Then, the scanning signal, the display signal, and the various control signals output from the control circuit are input to the driver LSI 32 through the FPC 33. The driver LSI 32 supplies voltage to each of the electrodes of the display area 42 at specified timing based on the input scanning signal, the display signal, and the various control signals.

A backlight unit (not shown) is provided on the back of the liquid crystal display panel. Then, the backlight unit is used to illuminate the liquid crystal display panel from the non-viewer side of the liquid crystal display panel. For example, an assembly in which a cold-cathode tube or a white LED is used as the light source and an optical waveguide, a lens sheet, a diffusion sheet, a reflection sheet, and the like are used to transform that light source into the flat surface light source can be used as the backlight unit.

The operation of the above-described liquid crystal display devise is explained hereinafter. Liquid crystal is driven by the electric field between the pixel electrode and the common electrode, and the alignment direction of the liquid crystal located between the substrates is changed. In this way, the polarization state of the light passing through the liquid crystal layer 31 is changed. That is, the polarization state of the light, which has linear polarization after passing through the polarizing plate, is changed by the liquid crystal layer 31. Specifically, the light from the backlight unit becomes linear polarization light by the polarizing plate 13 provided on the array substrate 10 side. As the linear polarization light passes through the liquid crystal layer 31, the polarization state is changed.

Then, the amount of the light that passes through the polarizing plate located on the opposed substrate 20 side varies depending on the polarization state. That is, the amount of the light that passes through the polarizing plate 23 on the viewable side varies from the amount of the transmitted light that is radiated from the backlight unit and passes through the liquid crystal display panel. The alignment direction of the liquid crystal changes depending on the applied display voltage. Therefore, the amount of the light that passes through the polarizing plate 23 on the viewer side can be changed by controlling the display voltage. That is, a desired image can be displayed by changing the display voltage on a pixel-by-pixel basis.

In a liquid crystal display devise having the above-described structure, the conductive film 21 is formed roughly throughout the entire surface of the opposed substrate 20. Furthermore, the conductive film 21 is electrically connected to the ground electrode 11 through the Ag paste 34, and maintained at the reference potential. That is, electrical charge in the conductive film 21 is moved to ground by the ground electrode 11. In this way, it can suppress the influence of external electrical fields, and thereby suppressing the disturbance in the alignment state of the liquid crystal. Therefore, it can improve the display characteristics of a liquid crystal display devise. Furthermore, an overhang area 41 is provided in a part of the edge portion on the projection area 40 side of the opposed substrate 20. The overhang area 41 is formed in any given area that does not interfere with the placement of the driver LSI 32 or the like. Accordingly, it is not necessary to increase the projection area 40, and thereby enabling to minimize the frame area 43.

Note that there is no specific restriction on the formation of the conductive film 21, provided that the conductive film 21 can suppress the influence of external electrical fields and can be connected to the ground electrode 11 through the Ag paste 34. For example, the conductive film 21 may be formed on the surface of the opposed substrate 20 that faces the array substrate 10. Furthermore, the conductive film 21 is not necessarily formed roughly throughout the entire surface of the opposed substrate 20.

Next, a specific method of manufacturing the above-described liquid crystal display devise is explained hereinafter. Firstly, a first mother substrate having a plurality of array substrate portions, and a second mother substrate having a plurality of opposed substrate portions are prepared. The array substrate portions and the opposed substrate portions will become the array substrates 10 and opposed substrates 20 respectively in a later process. Incidentally, the first and second mother substrates correspond to the insulating substrates of the array substrate 10 and the opposed substrate 20 respectively. Furthermore, the insulating substrate may be formed from light transparent material such as glass, polycarbonate, or acrylic resin.

Firstly, a method of manufacturing a first mother substrate having a plurality of array substrate portions is explained hereinafter. The patterns of switching elements, lines, pixel electrodes, common electrodes and the likes are formed on the one surface of the first mother substrate by repeatedly carrying out a pattern formation process including film formation, patterning by photolithography, etching, and the like. In this way, a plurality of array substrate portions are formed in a matrix pattern on the first mother substrate. Furthermore, the pattern of ground electrodes 11 is also formed in a similar process. The ground electrodes 11 may be formed simultaneously with the formation of the other electrodes or the like, or may be formed in an additional pattern formation process.

Then, an alignment layer 12, which is composed of polyimide diluted with a diluent or mixed resin of polyamic acid and polyimide, is coated to the pattern formation surface of the first mother substrate by a printing method mainly using a transfer plate. After that, it is baked on a heating stage equipped with an infrared heater for about 15 minutes at a temperature of 210-240° C. This baking process volatilizes the diluent, so that the alignment layer 12 is reduced to 50-150 nm in thickness. After that, the directions of the polyimide alignment layer molecules are aligned by rubbing the surface of the alignment layer 12 by a rotating roller around which cloth of rayon or cotton is wrapped. This process is, in general, called “rubbing process”. In this way, when liquid crystal is filled, the molecules of the liquid crystal turn to a specific direction. After that, cleaning with IPA and pure water, and drying are carried out.

Next, a method of manufacturing a second mother substrate having a plurality of opposed substrate portions is explained hereinafter. In this example, the patterns of color filters and a BM are formed on one surface of the second mother substrate in a similar method to that for the first mother substrate. Furthermore, column spacers are formed in a speckled manner over the BM pattern in a similar method. In this way, a plurality of opposed substrate portions are formed in a matrix pattern on the second mother substrate. Then, similarly to the first mother substrate, an alignment layer 22 is coated to the pattern formation surface of the opposed substrate 20, and the baking and the rubbing process are carried out. After that, cleaning with IPA and pure water, and drying are carried out. Next, sealing material 30 composed of epoxy resin is formed along the peripheral portion of the display area 42 by printing or using a dispenser. Then, preliminary heating is carried out to volatilize volatile components within the resin. Incidentally, the sealing material 30 does not completely enclose the peripheral portion. That is, the peripheral portion has a small opening portion in a part of it. The opening portion is, for example, formed on the opposite side to the terminal side (opposite side to the projection area 40), and serves as a liquid crystal filling port when liquid crystal is filled into the cell.

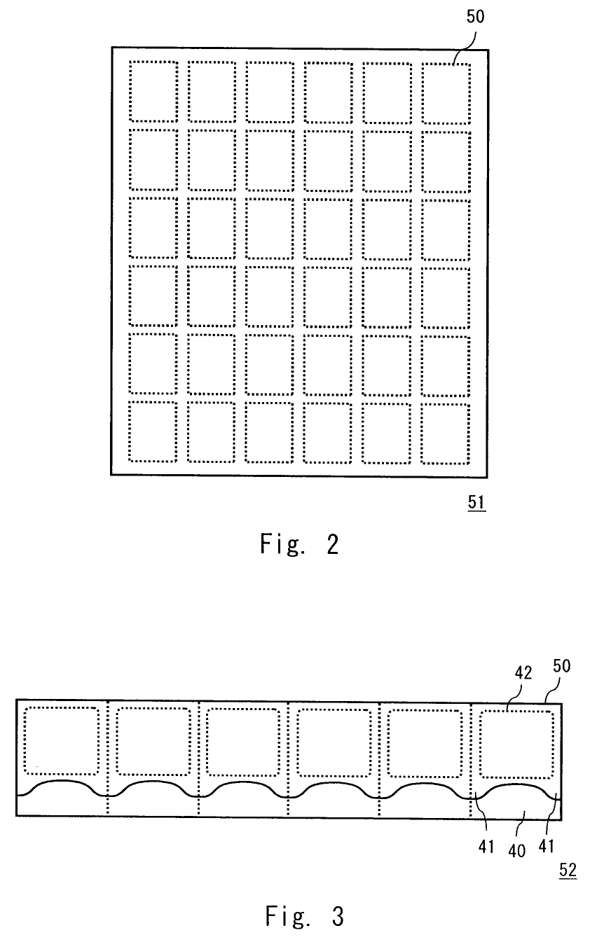

The first mother substrate and the second mother substrate for which preliminary processes are carried out in such a manner are bonded together by the sealing material 30 such that the pattern formation surfaces of both substrates face each other. At this point, after the array substrate portions and the opposed substrate portions are precisely aligned, they are superimposed with each other. Then, they are heated to about 150° C. so that the epoxy resin of the sealing material 30 undergoes cross-linking reaction. As shown in FIG. 2, a plurality of cells 50, each of which has the array substrate portion and the opposed substrate portion arranged in opposed positions, are formed in a matrix pattern in this manner. The resulting assembly, in which the first mother substrate and the second mother substrate are bonded together and a plurality of cells 50 are formed in this manner, is called “large cell 51” hereinafter. FIG. 2 is a top view showing the structure of the large cell 51.

Then, after the surfaces of the large cell 51 are cleaned, it is put in a sputtering device to form a conductive film 21 over the entire back surface of the second mother substrate. Note that the back surface of the second mother substrate is the opposite surface of the second mother substrate to the pattern formation surface, i.e., the surface on which a polarizing plate 23 will be stuck with a conductive film 21 interposed therebetween in a later process. In this example, an ITO film composed mainly of iridium is used as the conductive film 21. Needless to say, other transparent conductive films such as a ZnO film may be also used as the conductive film 21. The thickness of the ITO film is preferably 50-100 nm. Furthermore, although a formation method using sputtering is explained in the example, it may be carried out by other conductive film coating methods without degrading the function.

After that, the large cell 51 shown in FIG. 2 is severed into plural rows of cells 50, in each of which a plurality of cells 50 are horizontally aligned. That is, the large cell 51 is severed into plural sticks 52, in each of which a plurality of cells 50 are connected in a row as shown in FIG. 3. FIG. 3 is a top view showing the structure of the stick 52. Then, scribe lines (cutting lines), which define the outer shapes, are incised by using super steel or a diamond wheel. At this point, the scribe lines are formed in straight lines in a horizontal direction. Furthermore, a scribe line is incised in a curved line on the projection area 40 side of the opposed substrate portion. In this way, the side edge on the projection area 40 side of the opposed substrate portion is, when viewed from the top, formed in a curved line, and the edge portion on the projection area 40 side of the opposed substrate portion is curved. Then, an overhang area 41 is formed in a part of the side edge. Alternatively, the overhang area 41 may be formed on the projection area 40 side of the opposed substrate portion by incising straight scribe lines. However, the scribe line is preferably incised in a curved line as described above since it can be cut more easily. In this example, the overhang areas 41 are formed in both ends of the side edge of the opposed substrate portion. In this way, a continuous scribe line can be formed on the stick 52. That is, a single continuous scribe line is formed over a plurality of cells 50 on the stick 52 without dividing the scribe line for each cell. In this way, the scribe line can be easily formed. After that, the sticks 52 are cut out by applying pressure in the vicinity of the scribe lines so as to develop the lengthwise cracks along the scribe lines.

Next, liquid crystal is filled into each cell 50 in the stick 52 from its respective liquid crystal filling port. This process is carried out by filling liquid crystal from the liquid crystal filling port using a vacuum filling method. In the vacuum filling method, for example, a liquid crystal boat containing liquid crystals and the cell 50 are disposed in a vacuum chamber. In this example, the cell 50 is disposed with the liquid crystal filling port pointing downward so that the liquid crystal filling port and the liquid crystal boat face each other. Then, the gap within the cell 50 and the liquid crystal are degassed by exhausting air and thus reducing the pressure within the vacuum chamber. After that, the liquid crystal filling port located at the lower edge of the cell 50 is brought into contact with the liquid crystal in the liquid crystal boat. Then, by increasing the pressure within the vacuum chamber to the atmospheric pressure, the liquid crystal in the liquid crystal boat is sucked into the cell 50 by the capillary action and the pressure difference between the inside and outside of the cell 50.

After that, the liquid crystal filling port is wiped, and end-sealing material composed of ultraviolet curing resin is coated to the liquid crystal filling port. Then, the liquid crystal filling port is sealed by curing the resin by irradiation with ultraviolet light. The stick 52 having cells 50, each of which is filled with liquid crystal in this manner, is divided into individual cell pieces. In this example, lateral sides of the cell 50 are cut in straight lines in a similar method to the above-described method. Then, the individual cell pieces, on each of which the array substrate 10 and the opposed substrate 20 are arranged in opposed positions, are obtained. Then, cleaning process using the combination of water, detergent, and ultrasound is carried out in order to remove the liquid crystal that scattered around the periphery of the cell 50.

After that, polarizing plates 13 and 23 are stuck on both sides of the cell 50. The polarizing plates 13 and 23 are stuck with precise alignment. Next, a driver LSI 32 used to drive the switching element within the display area 42 is mounted. To that end, the bump of the driver LSI 32 is precisely aligned so as to sit on the electrode terminals 60 of the liquid crystal display panel. Then, the driver LSI 32 is preliminarily mounted on the liquid crystal display panel with an anisotropic conductive film (not shown) interposed therebetween. After that, the anisotropic conductive film is cured by using a heating and pressurizing tool. In this way, the bump of the driver LSI 32 is electrically connected to the electrode terminals 60 of the liquid crystal display panel. Similarly, a FPC 33 used to input signals from an external signal source to the driver LSI 32 is connected through an anisotropic conductive film (not shown). The FPC 33 is formed in an area that is located on the edge portion side of the array substrate 10 with respect to the driver LSI 32.

After that, Ag paste 34 is coated by using a dispenser in order to electrically connect the conductive film 21 formed on the opposed substrate 20 and the ground electrode 11 formed on the array substrate 10. The Ag paste 34 is integrally formed on the conductive film 21 in the overhang area 41 of the opposed substrate 20 and on the ground electrode 11. In this way, the conductive film 21 and the ground electrode 11 are electrically connected to each other. Furthermore, since the polarizing plate 23 is not formed in the overhang area 41, the conductive film 21 and the ground electrode 11 can be easily connected. That is, the provision of the overhang area 41 eliminates the need to take the positional relation between the polarizing plate 23 and the opposed substrate 20 into consideration. Incidentally, the diluent and Ag particles tend to separate in the Ag paste 34. Therefore, the surrounding area of the syringe is preferably maintained at a certain temperature by using a temperature control heater. Finally, the Ag paste 34 is cured by heating it for a certain time period by an oven. Note that the only requirement for the Ag paste 34 is that the Ag paste 34 should be coated to at least one of two overhang areas 41 in the opposed substrate 20 that is opposed to the area where the ground electrode 11 is formed.

By using the manufacturing method explained above, it can suppress the influence of external electrical fields, and thereby suppressing the disturbance in the alignment state of the liquid crystal. Furthermore, it can improve the display characteristics of a liquid crystal display devise. Furthermore, since a larger number of cells 50 can be manufactured from one pair of mother substrates as explained above, it can provide a liquid crystal display device at a lower cost.

### Second Embodiment

This embodiment is different from the first embodiment in that insulating resin is formed in the overhang area 41. Incidentally, other structures are similar to those of the first embodiment, and therefore their explanations are omitted as appropriate.

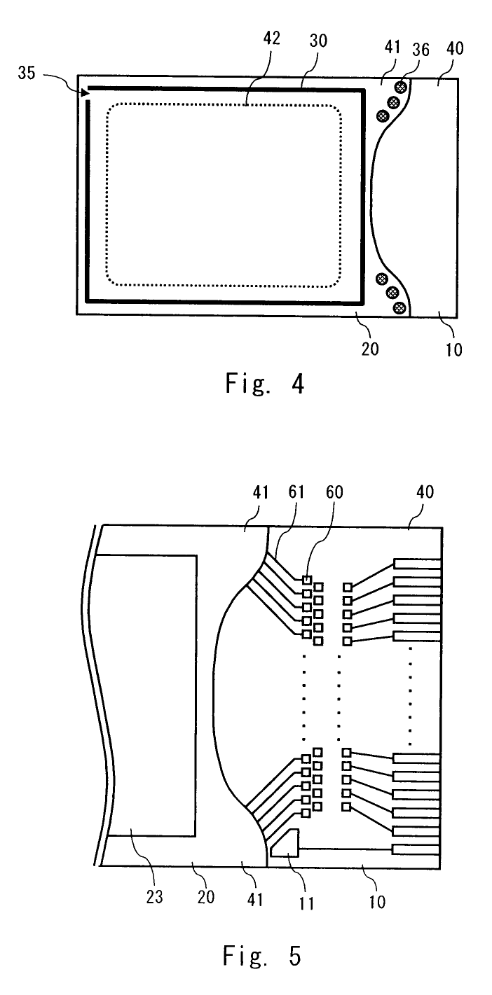

Insulating resin in accordance with this embodiment of the present invention is explained hereinafter with reference to FIG. 4. FIG. 4 is a top view showing a coating place of insulating resin 36. The insulating resin 36 is, for example, formed from the same material as the sealing material 30. The sealing material 30 is coated or printed along the peripheral portion of the display area 42 such that the sealing material 30 surrounds the display area 42. Incidentally, a liquid crystal filling port 35 is formed at a corner potion on the opposite side to the terminal side in this example. In this embodiment of the present invention, an insulating resin 36 is formed in the overhang area 41. That is, the sealing material 30 is formed between the array substrate 10 and the opposed substrate 20 so as to surround the display area 42, and the insulating resin 36 is formed from the same material as the sealing material 30 in the overhang area 41. Since the insulating resin 36 is coated in the overhang area 41 and is arranged between the array substrate 10 and opposed substrate 20 in this way, the array substrate 10 and the opposed substrate 20 is also bonded together in the overhang area 41. Furthermore, it can also maintain the gap between the array substrate 10 and the opposed substrate 20 in the overhang area 41. In this way, it can prevent the opposed substrate 20 from being warped during the cutting process, and thereby preventing fractures during the cutting process. Therefore, it can maintain satisfactory cutting precision. Furthermore, the insulating resin 36 formed in the overhang area 41 may be coated in a speckled manner as shown in FIG. 4. Needless to say, the insulating resin 36 may be also applied in a linear shape. Furthermore, although it is preferable to form the insulating resin 36 in the overhang area 41 from the same material as the sealing material 30, other types of insulating material can be also used for that purpose. For example, the insulating resin 36 may formed in the overhang area 41 from the same material as the column spacers. In this way, since it does not require an additional manufacturing process, it can improve the productivity.

### Third embodiment

Although the shape of the ground electrode 11 is not specified in the first embodiment, the ground electrode 11 is formed in a specific shape described below in this embodiment. Incidentally, other structures are similar to those of the first embodiment, and therefore their explanations are omitted as appropriate.

The shape of the ground electrode 11 in accordance with this embodiment of the present invention is explained hereinafter with reference to FIG. 5. FIG. 5 is a top view showing the structure of the projection area 40 before the driver LSI 32 and the FPC 33 are connected. The driver LSI 32 is connected roughly at the center portion of the projection area 40. Therefore, electrode terminals 60, which will be connected to the bump of the driver LSI 32, are disposed roughly at the center portion of the projection area 40. Furthermore, output lines 61 extending from the display area 42 are also formed in the projection area 40. The electrode terminals 60 are provided at the end portions of the output lines 61. The output lines 61 are connected to the gate signal lines and the source signal lines of the display area 42, and supply scanning signals and display signals to them. Furthermore, the output lines 61 are also routed to the frame area 43 located in the vicinity of the display area 42. Therefore, the output lines 61 extend, in the projection area 40, in inclined directions with respect to a side adjoining the side edge on the projection area 40 side of the array substrate 10 (which is called “adjoining side” hereinafter). That is, the directions in which output lines 61 extend in the projection area 40 are inclined with respect to the long sides of the rectangular-shaped array substrate 10.

Furthermore, the ground electrode 11 is formed in an area of the array substrate 10 that are opposed to the vicinity of the overhang area 41, in particular in an area in the vicinity of and outside of the output lines 61. Furthermore, one side of the ground electrode 11 that is located on the output line 61 side and on the display area 42 side is inclined with respect to the adjoining side of the array substrate 10. The ground electrode 11 has one side that is substantially parallel to the extending direction of the output lines 61, which is inclined with respect to the long sides of the array substrate 10. Therefore, that a side of the ground electrode 11 becomes closer to the adjoining side as it becomes closer to the display area 42. In this way, the distance from the edge of the ground electrode 11 to the adjoining side varies over the long side direction of the array substrate 10. In this example, the ground electrode 11 has such a shape that at least the corner portion located on the output line 61 side and on the display area 42 side is chamfered. Specifically, the ground electrode 11 has such a shape that the corner portion of the rectangle is cut off in a straight line. That is, the ground electrode 11 has one side, which is inclined with respect to the two sides of the ground electrode 11 that cross each other at right angles. In this way, the ground electrode 11 can be formed in the vicinity of the output lines 61 without intersecting the output lines 61. It can further minimize the projection area 40, and thereby enabling to realize a narrower frame. Furthermore, it is preferable that, at the least, one side located on the output line 61 side and on the display area 42 side is roughly parallel to the output lines 61. In this way, the ground electrode 11 can be formed in an area closer to the output lines 61.

Note that although it is preferable to cut off the corner of the ground electrode 11 in a straight line, the shape of the ground electrode 11 is not limited to this exact example. The ground electrode 11 may be formed in curved lines or the likes, provided that the ground electrode 11 can be disposed in the vicinity of and outside of the output lines 61. Furthermore, the ground electrode 11 may have such a shape that more than one corner is cut off. Alternatively, the ground electrode 11 may be formed in other polygons such as a triangle, a polygon, or an octagon.

### Fourth Embodiment

This embodiment is different from the first embodiment in the structure in which electrical charge in the conductive film 21 is moved to ground. Specifically, the structures of the ground electrode 11 and the Ag paste 34 of this embodiment are different from those of the first embodiment. Incidentally, other structures are similar to those of the first embodiment, and therefore their explanations are omitted as appropriate.

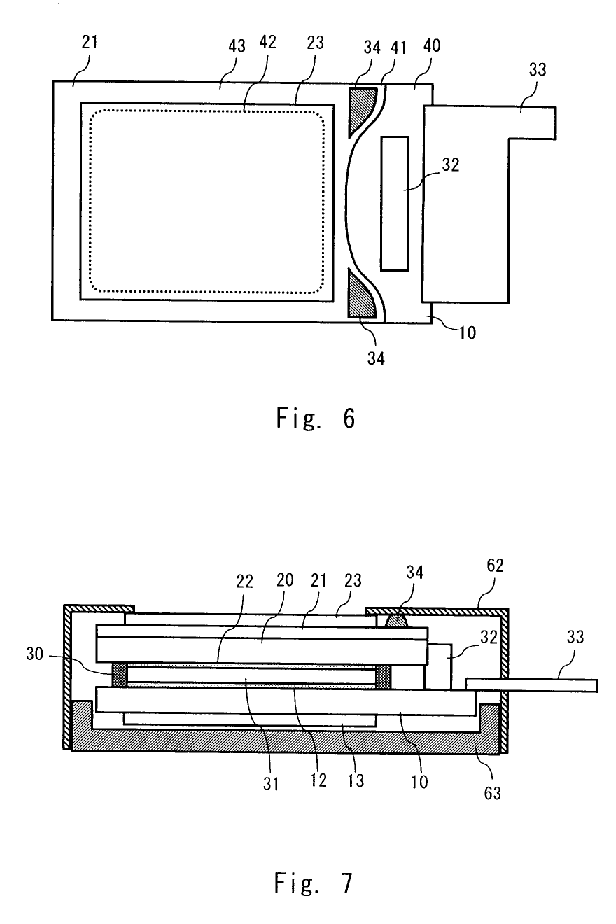

The structure of a liquid crystal display devise in accordance with this embodiment of the present invention is explained hereinafter with reference to FIGS. 6 and 7. FIG. 6 is a top view showing the structure of a liquid crystal display panel. FIG. 7 is a cross-section showing the structure of the liquid crystal display panel. As shown in FIG. 6, Ag paste 34 is coated to the overhang area 41 in a similar manner to the first embodiment. However, in contrast to the first embodiment, the Ag paste 34 is formed roughly over the entire areas of two overhang areas 41 with a uniform height. Furthermore, the Ag paste 34 is formed on the conductive film 21 so as to directly contact to it.

A liquid crystal display panel shown in FIG. 6 is mounted to a backlight unit 63 while being precisely aligned with the backlight unit 63 as shown in FIG. 7. Then, the liquid crystal display panel is fixed to the backlight unit 63 by double-faced adhesive tape that is already adhered on the backlight unit 63. Then, the liquid crystal display panel and the backlight unit 63 are covered with a conductive frame 62 from above the liquid crystal display panel in order to protect them. Furthermore, the conductive frame 62 has an opening at the center portion of it, so that the conductive frame 62 is formed in a frame-shape surrounding the liquid crystal display panel. Then, the sides of the conductive frame 62 are fixed to the backlight unit 63 by swaging or using screws. The conductive frame 62 is disposed on the front side (viewer side) of the liquid crystal display panel. The back side (surface on the liquid crystal display panel side) of the conductive frame 62 is configured so as to unfailingly contact with and electrically connect to the Ag paste 34. The conductive frame 62 is, for example, composed of conductive metallic material such as SUS. The structure like this eliminates the need to form the ground electrode 11, and thereby making the manufacture easier.

### Fifth Embodiment

The fourth embodiment has such a structure that the Ag paste 34 and the conductive frame 62 directly contact with each other. By contrast, the Ag paste 34 and the conductive frame 62 do not directly contact with each other in this embodiment. Incidentally, other structures are similar to those of the fourth embodiment, and therefore their explanations are omitted as appropriate.

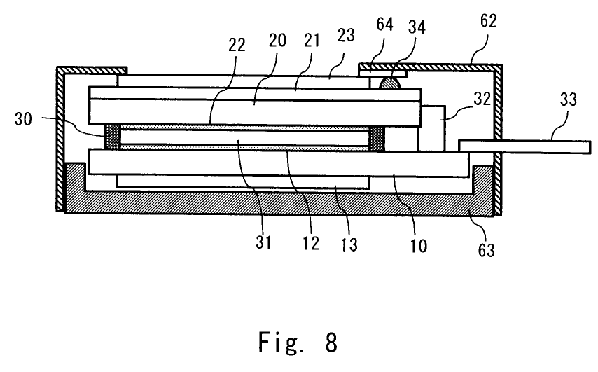

The structure of a liquid crystal display devise in accordance with this embodiment of the present invention is explained hereinafter with reference to FIG. 8. FIG. 8 is a cross-section showing the structure of a liquid crystal display devise. Similarly to the fourth embodiment, Ag paste 34 is applied to the liquid crystal display devise in accordance with this embodiment of the present invention. Then, conductive cushion material 64 is formed between the conductive frame 62 and the Ag paste 34. That is, the cushion material 64 is formed in the portion corresponding to the portion in the fourth embodiment where the Ag paste 34 contacts with the conductive frame 62. Then, the conductive frame 62 and the Ag paste 34 are electrically connected to each other through the cushion material 64. In FIG. 8, conductive rubber is used as the cushion material 64. Then, the conductive rubber is stuck on the portion of the conductive frame 62 where the Ag paste 34 contacts with. In this way, it can prevent the conductive frame 62 and the Ag paste 34 from being disengaged and electrically disconnected even when the device is subjected to vibration and impact.

Note that although a conductive rubber is used as an example of the cushion material 64 in the above-described embodiment, other types of material such as conductive or non-conductive cushion material wrapped by conductive tape or the like may be also used for that purpose. Furthermore, the advantageous effects of the present invention can be also obtained by using a structure where above-described embodiments are combined as appropriate.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A liquid crystal display device having a liquid crystal display panel including a first substrate and a second substrate arranged in opposed positions, comprising:
a display area;
a projection area where one edge of the first substrate projects beyond the second substrate on the outside of the display area;
an electrode terminal formed in the projection area;
an overhang area where a part of a side edge on the projection area side of the second substrate overhangs, when viewed from the top, toward a side edge on the projection area side of the first substrate;
a conductive film formed above the second substrate; and
a conductive material formed in the overhang area, the conductive material being electrically connected to the conductive film.

2. The liquid crystal display device according to claim 1, further comprising a ground electrode formed above the first substrate to which a reference potential is supplied,
wherein the ground electrode is electrically connected to the conductive material.

3. The liquid crystal display device according to claim 1, wherein the overhang area is, when viewed from the top, provided in an end portion of the side edge on the projection area side of the second substrate and formed in a curved line.

4. The liquid crystal display device according to claim 1, further comprising an output line extending, in the projection area, in the inclined direction with respect to a adjoining side adjoining the side edge of the first substrate located in the projection area side,
wherein a first point on the side of the ground electrode that is located on the display area side and on the output line side is located closer to the display side than a second point on the side of the ground electrode that is located on the display area side and on the output line side, a distance from the first point to adjoining side is shorter than a distance from the second point to adjoining edge.

5. The liquid crystal display device according to claim 1, further comprising insulating resin to maintain the gap between the first substrate and the second substrate.

6. The liquid crystal display device according to claim 5, further comprising sealing material formed so as to surround the display area between the first substrate and the second substrate,
wherein the insulating resin and the sealing material are formed from the same material.

7. The liquid crystal display device according to claim 1, further comprising a conductive frame to cover the liquid crystal display panel,
wherein the conductive material is electrically connected to the conductive frame.

8. The liquid crystal display device according to claim 7, further comprising conductive cushion material formed between the conductive frame and the conductive material,
wherein the conductive frame and the conductive material are electrically connected to each other through the conductive cushion material.
